(19) United States
(12) Patent Application Publication
(10) Pub. No.: US 2010/0018060 A1
(43) Pub. Date: Jan. 28, 2010

(54) Cutting tool

(76) Inventor: Xueliang (Victor) Lin, Yangjiang (CN)

Correspondence Address: LAW OFFICES OF CLEMENT CHENG, 17220 NEWHOPE STREET #127, FOUNTAIN VALLEY, CA, 92708, US

(21) Appl. No.: 12/288,511

(22) Filed: Oct. 21, 2008

(30) Foreign Application Priority Data
Jul. 22, 2008 (CN) 200820127443.7

(51) Int. Cl. B26B 3/06

(52) U.S. Cl. 30/151

(57) ABSTRACT

This invention provides a cutting tool, comprising: a housing; as well as the tool bit holder, which may rotate, fix and may be held in the housing. The tool bit holder has a tool bit holder main body top that lodges with the tool bit main body bottom to hold the removable bit. The bit forms specifically with the knife edge opposite one side which has at least one localization selector. In the tool bit holder, the main body member has a localization member which may move with the localization selector. The localization member: sets the position, and should set in the position so that the localization member coordinates with the localization selector. In the release position, the localization member is separated from the coordination to the release position at the localization selector. The bit disassembles conveniently and allows different positions and good utility.

This application claims priority from Chinese application 200820127443.7 filed Jul. 22, 2008 by Lin, Victor.

### FIELD OF THE INVENTION

The present utility invention relates to household goods, specifically a folding tool.

### BACKGROUND TECHNOLOGY

At present in the market there are a variety of folding tools. The folding tools include a variety of implements, and tools such as the cutting tool which has good utility. Simultaneously because they are very portable, they have obtained more and more widespread use.

But, the current cutting tools have a problem, namely, the cutting tool's tool bit is unable to be user replaced. If the blade wears or otherwise is struck or the knife edge is damaged, then one can only replace it with a new cutting tool. Thus, current tools have good operational performance, but also waste. A minority of the tools allow replacement of the blade bit, however the replacement process is also very tedious, requires partial disassembly of the cutting tool or cutting tool's housing before completing replacement.

Therefore, the present invention seeks to provide a kind of new cutting tool, which may overcome the above existing technical shortcomings.

### SUMMARY OF THE INVENTION

This utility invention has a goal to provide a type of cutting tool having a bit that may be replaced conveniently.

In view of the above goal, this model utility has provided one kind of cutting tool, comprising: a housing housing; as well as the tool bit holder, which may rotate, fix and may be held in the housing. The tool bit holder has a tool bit holder main body top that lodges with the tool bit main body bottom to hold the removable bit. The bit forms specifically with the knife edge opposite one side which has at least one localization selector. In the tool bit holder, the main body member has a localization member which may move with the localization selector. The localization member: sets the position, and should set in the position so that the localization member coordinates with the localization selector. In the release position, the localization member is separated from the coordination to the release position at the localization selector.

Optimally, the present invention cutting tool's bit's localization selector is a scoop channel. In the localization member is formed a shape with a bulge which corresponds with the above scoop channel. The bulge in the localization position mates with the bit's scoop channel. The bulge is separated from the mate with the scoop channel, when in the release position.

Optimally, the present invention cutting tool's bit's localization selector fits with a bulge. The localization member is shaped to provide a bulge corresponding to the scoop channel. The scoop channel in the localization position mates with the bulge. The scoop channel is separated from the coordination in the release position with the bulge.

Optimally, the present invention cutting tool also includes a spring, this spring is placed in the tool bit main body, and mounts underneath the localization member. The spring has a predefined bias quantity.

Optimally, the present invention cutting tool has a notch opening on the tool bit holder main body. The crown of the localization member is revealed to the exterior through the notch opening on the tool bit holder main body.

Optimally, the present invention cutting tool has a localization member top portion comprising a retainer. The retainer is revealed from the notch opening to the outside of the tool bit holder main body.

Optimally, in the present invention cutting tool, the tool bit holder main body has an accommodation member. The localization member installs in this accommodation member.

Optimally, in the present invention cutting tool, the tool bit holder main body is comprised of a main body top and a main body bottom so that the bit is inserted in the accommodation slot space formed between the main body top and the main body bottom.

Optimally, according to this model utility cutting tool, the main body top and main body bottom are formed as covers with an observation window. The observation window is designed to show the bit localization selector.

The utility invention technical effect includes: first, the cutting tool has the localization selector, and also the tool bit main body has a localization selector mating means, so that one may set the bit through the mating means. When the two are separated from the mate, the bit conveniently disassembles from the tool bit main body.

Next, on the bit are many localization selectors according to this invention. With the many localization selectors and via the localization member, one may set the bit relative to the tool bit main body in different positions, thus enhancing the cutting tool's usability.

The above general description and the below detailed description are descriptive, the goal being to provide a foundation for the claims of this invention.

### BRIEF DESCRIPTION OF THE DRAWINGS

The attached figures showing construction are helpful for further understanding the invention. The attached figures provide a graphic depiction to this invention and provides an implementation example, which combine with the specification for describing the principle of the invention. The part numbering is consistent throughout the attached figures:

FIG. 1 shows an example of the optimal implementation, being a cutting tool, the cutting tool also including another tool type being the bit holder.

FIG. 2 shows the cutting tool of FIG. 1, in the condition which the tool bit holder assembly is finished.

FIG. 3 is an exploded view of the cutting tool's tool bit of FIG. 1.

FIG. 4 is the tool bit of FIG. 2.

FIG. 5 is the tool bit's localization member of FIG. 2.

FIG. 6 is the top view of the spring.

FIG. 7 is the side view of a spring.

FIG. 8 shows the main body top of the tool bit holder of FIG. 2.

FIG. 9 shows the main body bottom of the tool bit holder of FIG. 2.

Housing 10
Tool Bit Holder 20
Main Body Top 21
Notch Opening 21a
Observation Window 21b
Main Body Bottom 22
Accommodation Member 22a
Observation Window 22b
Removable Blade Bit 23
Localization Selector 23a
Localization Selector 23b
Localization Member 24
Bulge 24a
Retainer 24b
Flat Spring 25

### DETAILED DESCRIPTION

The preferred embodiment will refer to the attached figures to carry on the explanation of the present invention.

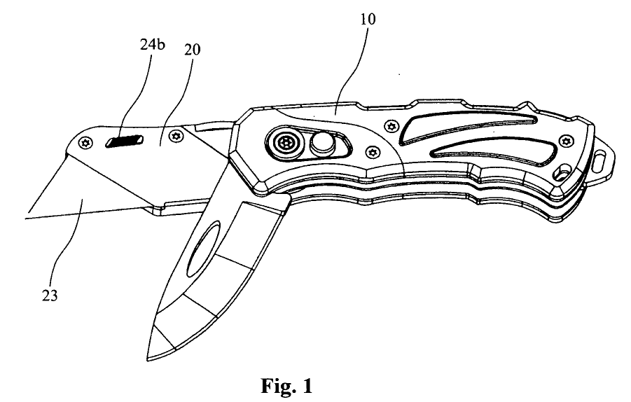

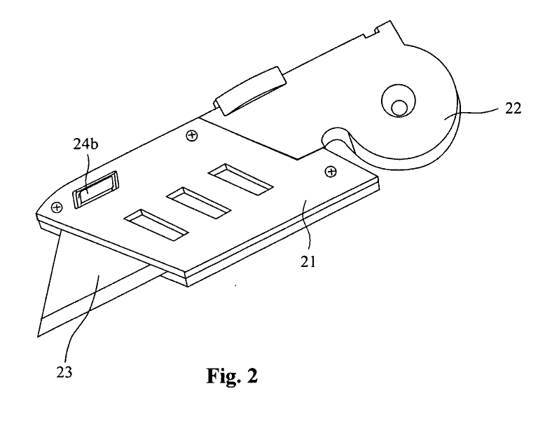

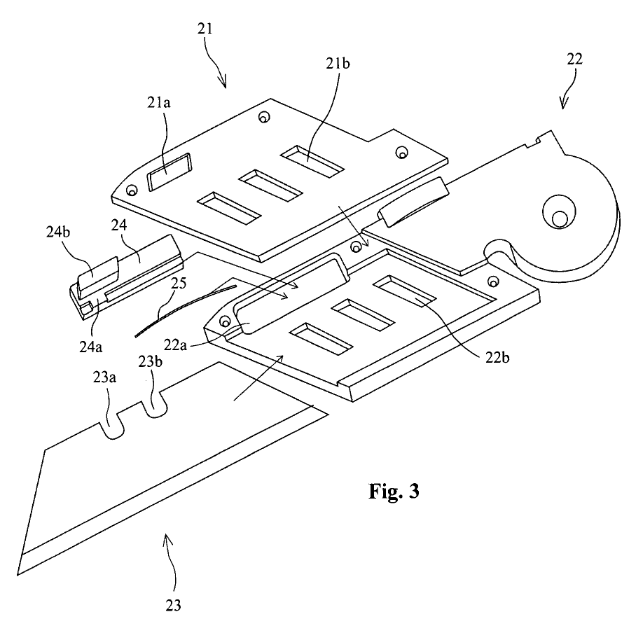

FIG. 1 shows the optimal implementation example being the cutting tool, and this cutting tool also includes another type of knife. As seen in FIG. 1, this cutting tool mainly includes the housing 10 as well as the tool bit holder 20. The tool bit holder 20 may rotate and fix in an end of housing 10 and may retain in housing 10. As shown in FIGS. 2, 3, the tool bit holder 20 comprises the main body top 21 and main body bottom 22. An accommodation slot space is formed between the main body top 21 and the main body top 22 to hold removable blade 23. In this embodiment, the main body top 21 is attached by through screw fastening means to the main body bottom 22.

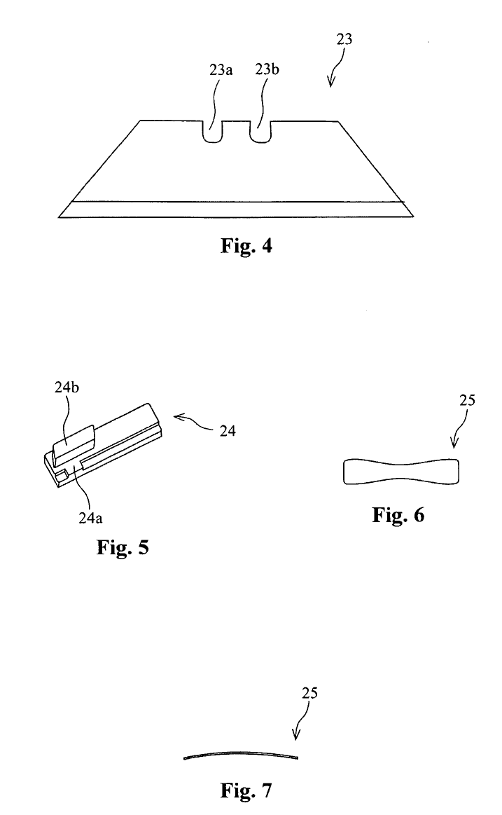

More specifically, as shown in FIG. 4, the bit 23 forms with a knife edge on one side and oppositely with two scoop channels (localization selector) 23a, 23b. The tool bit main body members 21, 22 in joined configuration have a movable setting to provide adjustable placement according the scoop channel which is selected to lodge with localization member 24. The localization member 24 is formed with a contour and bit 23 has scoop channel 23a, 23b corresponding to bulge 24a (as shown in FIG. 5). This localization member 24 has a set position and a release position. In the set position, bulge 24a of localization member 24 has and scoop channel 23a of bit 23 or the localization selector 23b meets and couples with bulge 24a. In the release position, bulge 24a of localization member 24 and scoop channel 23a, 23b of bit 23 are decoupled. When bulge 24a and scoop channel 23a, 23b couple, the bit 23 is fixed in the tool bit main body 21, 22 at the respective positions. When bulge 24a and scoop channel 23a, 23b are decoupled, the bit 23 disassembles from the tool bit main body top 21, and tool bit main body bottom 22. Selective engagement of bulge 24a in scoop channel 23a or 23b provides bit 23 adjustment according to user need for elongating the blade position relative to the tool bit holder 20.

In an alternate reversed embodiment, the localization selector of bit 23 may be formed as a bulge, and the corresponding localization member 24 has a corresponding scoop channel coupling with the bulge. The scoop channel meets in the localization position with the bulge bit's. The localization on the scoop channel is decoupled in the release position with bit's bulge.

The flat spring according to the preferred embodiment is spring 25 as seen in FIGS. 6, 7. This flat spring 25 lodges in the tool bit main body 21, 22, and mounts under localization member 24. The flat spring 25 has an initial predetermined bias which may and does press against and support localization member 24 from underneath.

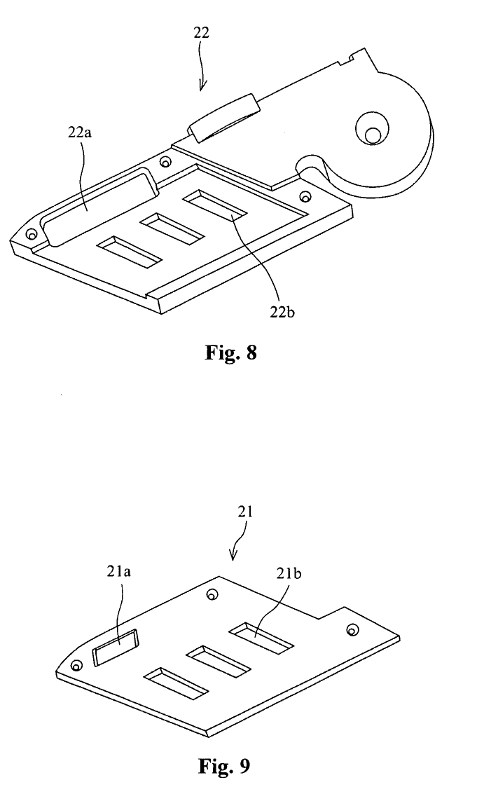

Specifically, as shown in FIG. 8, the main body top 21 has notch opening 21a. Localization member 24 has a retainer 24b at a top portion as seen in FIG. 4, and retains on notch opening 21a to reveal bit status outside the tool bit main body. Thus, the retainer passes through so that the retainer 24b is constrained to move the localization member 24 in vertical motions. When one presses down holds retainer 24b, the localization member 24 has downward movement. When the top of bulge 24a on localization member 24 is lower than the bottom surface of bit 23, bulge 24a disengages from scoop channel 23a or 23b of bit 23, thus causing the bit 23 and the localization member 24 to decouple. Thus, the bit 23 can be removed from the tool bit holder formed of the main body members 21, 22 allowing extraction of the bit for bit 23 replacement. Optionally, the localization member 24 is not equipped with above retainer 24b, and instead the crown of the localization member 24 is exposed directly through the main body top 21 through notch opening 21a. Through the retainer, the crown of the localization member 24 similarly may also directly accomplish the above coordinated separation.

To install the localization member 24 in the tool bit main body members 21, 22, as seen in FIG. 9, the main body bottom 22 according to this preferred embodiment has an accommodation member 22a formed as a depression. The localization member 24 installs in the accommodation member 22a, and afterwards the main body top 21 covers the main body bottom 22 hearing the localization member 24 in the tool bit main body.

The specific installation order for the fore-mentioned figure relates to the tool bit holder 20. First the removable blade bit 23 is set on the main body bottom 22, then the flat spring 25 is laid in the main body bottom 22 accommodation member 22a. Afterwards, the localization member 24 is installed over the flat spring 25. Finally, one covers the main body top 21 over the main body bottom 22, and installs through screws or bolts to complete the present embodiment tool bit holder 20 assembly. The tool bit holder 20 may be used with existing technology with the housing 10 connection any suitable mode, the details of which are unnecessary to give. In addition, in this embodiment, the main body top 21 has three openings forming observation windows 21b, and the main body bottom 22 has three openings forming corresponding observation windows 22b. These observation windows 21b, 22b may be placed to expose scoop channel 23a, 23b of bit 23, and thus one may use these observation windows 21b, 22b to recognize bit 23 in different localization positions.

The above is only a preferred embodiment and does not limit the invention. Persons of ordinary skill in the art may devise obvious modifications to the invention. Obvious modifications within in the spirit and the principle of the invention which are obvious are included within the scope of the claims.

1. A cutting tool comprising:
a. a housing;
b. a tool bit holder that rotates, fixes and retains in the housing;
c. wherein the tool bit holder has a main body is comprised of a main body top a main body bottom,
d. a tool bit which is removable from the main body; wherein the bit forms a knife edge with an a localization selector opposite the knife edge; wherein the tool bit main body allows localization adjustment; and further comprising
e. a localization member coordinated to be user movable and engagable with a localization selector; wherein the localization member has a release position, wherein the release position releases the localization selector from the localization member.

2. The cutting tool of claim 1, wherein the localization selector of the bit are scoop channels; wherein the localization member has a bulge to which the scoop channels correspond; and wherein the bulge sets in position with the scoop channels, wherein the bulge in the release position decouples from the scoop channels.

3. The cutting tool of claim 1, wherein its characteristic lies, States the bit (23) the localization selector is a bulge; States the localization (24) on to form has the shape with to state the bulge correspondence the scoop channel; And states the scoop channel, in states sets in the position with to state the bit to state the bulge to coordinate in together, states the scoop channel in states in the release position with to state the bulge to be separated from the coordination.

4. The cutting tool of claim 1, wherein the cutting tool further includes a spring, wherein the spring is held in the tool bit main body, and is set under the localization member, wherein the spring has a predefined initial bias.

5. The cutting tool of claim 1, wherein the tool bit main body has a notch opening, wherein the localization member as a crown portion extending through the notch opening to be exposed outside the tool bit main body.

6. The cutting tool of claim 5, wherein the localization member has a crown portion forming a retainer retaining the localization member on the notch opening, wherein the retainer is exposed outside the tool bit main body.

7. The cutting tool of claim 1, wherein the tool bit main body has an accommodation member formed as a depression in which the localization member is installed.

8. The cutting tool of claim 1, wherein the tool bit main body top and main body bottom join to form an accommodation slot space in which the bit is installed.

9. The cutting tool of claim 1, wherein the main body top and main body bottom have openings forming observation windows, wherein the observation windows are designed to show position of the localization selector and the position of the bit.
